(19) United States
(12) Patent Application Publication
(10) Pub. No.: US 2020/0207898 A1
(43) Pub. Date: Jul. 2, 2020

(54) COMPOSITION AND POSITIVE-ELECTRODE BINDER COMPOSITION

(71) Applicant: DENKA COMPANY LIMITED, Tokyo (JP)

(72) Inventors: Soichiro NAKANISHI, Tokyo (JP); Takuya NARUTOMI, Tokyo (JP); Kyoichi INOUE, Ichihara-city (JP); Shigeru SUZUKI, Tokyo (JP); Jun WATANABE, Tokyo (JP)

(21) Appl. No.: 16/622,513

(22) PCT Filed: Jun. 13, 2018
(86) PCT No.: PCT/JP2018/022556

§ 371 Date: Dec. 13, 2019

(30) Foreign Application Priority Data
Jun. 13, 2017 (JP) 2017-115966

(51) Int. Cl. C08F 261/04; C08K 3/04; C08L 51/00; H01M 10/0525; H01M 4/62; H01M 4/525; H01M 4/131; H01M 4/505

(52) U.S. Cl. CPC C08F 261/04; C08K 3/04; C08L 51/003; H01M 10/0525; H01M 4/622; H01M 2004/028; H01M 4/525; H01M 4/131; H01M 4/505; C08F 2800/20; H01M 4/625

(57) ABSTRACT

An object of the present invention is to provide a composition having flexibility. A composition comprising a graft copolymer in which a monomer, including a (meth) acrylonitrile and a (meth) acrylic acid ester as a main monomer, graft-copolymerizes to a backbone polymer having a polyvinyl alcohol, wherein the polyvinyl alcohol has a saponification degree of 50 to 100 mol %, a content of the composition of the polyvinyl alcohol is 5 to 50% by mass, a total content of the (meth) acrylonitrile monomer unit and the (meth) acrylic acid ester monomer unit is 50 to 95% by mass, a content of the (meth) acrylonitrile monomer unit in a total of 100% by mass of the (meth) acrylonitrile monomer unit and the (meth)acrylate monomer unit is 20 to 95% by mass, a content of the (meth)acrylate monomer unit in a total of 100% by mass of the (meth) acrylonitrile monomer unit and the (meth)acrylate monomer unit is 5 to 80% by mass, the (meth) acrylic acid ester is a monomer whose homopolymer has a glass transition temperature of 150 to 300 K.

### TECHNICAL FIELD

The present invention relates to a composition, a binder composition for a positive electrode, a slurry for a positive electrode using the binder composition, and a positive electrode and a lithium ion secondary battery using the slurry.

### BACKGROUND ART

In recent years, a secondary battery has been used as a power source for electronic devices such as notebook computers, mobile phones. Moreover, development of hybrid vehicles and electric vehicle using the secondary battery is promoted to reduce the environmental load. Secondary batteries having high energy density, high voltage, and high durability are required for their power sources. Lithium ion secondary batteries are attracting attention as secondary batteries that can achieve high voltage and high energy density.

A lithium ion secondary battery is composed of a positive electrode, a negative electrode, an electrolyte, and a separator. The positive electrode is composed of a positive electrode active material, a conductive auxiliary agent, a metal foil, and a binder. As the binder, a fluorine resin such as polyvinylidene fluoride or polytetrafluoroethylene, a styrene-butadiene copolymer, and an acrylic copolymer are used (Patent Literatures 1 to 3).

As a binder for positive electrode for a lithium ion secondary battery, a binder (graft copolymer), having high binding properties and oxidation resistance, mainly composed of polyvinyl alcohol and polyacrylonitrile is disclosed (Patent Literature 4).

However, Patent Literatures 1 to 4 do not describe the glass transition temperature of (meth) acrylic acid ester.

### CITATION LIST

### Patent Literature

Patent Literature 1: JP2013-98123
Patent Literature 2: JP2013-84351
Patent Literature 3: JPH6-172452
Patent Literature 4: WO2015/053224

### SUMMARY OF INVENTION

### Technical Problem

The present invention has been made by taking the afore-mentioned circumstances into consideration, an object of the present invention is to provide a composition having flexibility.

### Solution to Problem

As a result of diligent efforts to achieve the above object, the present inventors have found that a composition using specific (meth) acrylic acid esters has flexibility.

Accordingly, the present invention provides the followings.

(1) A composition comprising a graft copolymer in which a monomer, including a (meth) acrylonitrile and a (meth) acrylic acid ester as a main monomer, graft-copolymerizes to a backbone polymer having a polyvinyl alcohol, wherein the polyvinyl alcohol has a saponification degree of 50 to 100 mol %, a content of the composition of the polyvinyl alcohol is 5 to 50% by mass, a total content of the (meth) acrylonitrile monomer unit and the (meth) acrylic acid ester monomer unit is 50 to 95% by mass, a content of the (meth) acrylonitrile monomer unit in a total of 100% by mass of the (meth) acrylonitrile monomer unit and the (meth)acrylate monomer unit is 20 to 95% by mass, a content of the (meth)acrylate monomer unit in a total of 100% by mass of the (meth) acrylonitrile monomer unit and the (meth)acrylate monomer unit is 5 to 80% by mass, the (meth) acrylic acid ester is a monomer whose homopolymer has a glass transition temperature of 150 to 300 K.

(2) The composition of (1), wherein the composition optionally comprises at least one of a (meth) acrylonitrile-(meth) acrylic ester based non-graft copolymer and a non-graft polymer having polyvinyl alcohol.

(3) The composition of (1), wherein the (meth) acrylic acid ester has one or more structures selected from the group consisting of linear alkyl, branched alkyl, linear or branched polyether, cyclic ether, and fluoroalkyl.

(4) The composition of any one of (1) to (3), wherein a graft ratio of the graft copolymer is 150 to 1,900%.

(5) The composition of any one of (1) to (3), wherein the average polymerization degree of the polyvinyl alcohol is 300 to 3,000.

(6) A binder composition for a positive electrode, comprising the composition of any one of (1) to (5).

(7) A slurry for a positive electrode, comprising the binder composition of (6) and a conductive auxiliary agent.

(8) A slurry for a positive electrode, comprising the binder composition of (6), a positive electrode active material and a conductive auxiliary agent.

(9) The slurry of (7) or (8), wherein the conductive auxiliary agent is at least one selected from the group consisting of (i) fibrous carbon, (ii) carbon black, and (ill) a carbon composite in which fibrous carbon and carbon black are interconnected.

(10) The slurry of any one of (7) to (9), wherein a solid content of the binder composition is 0.01 to 20% by mass with respect to a total solid content of the slurry.

(11) The slurry of (8), wherein the positive electrode active material is at least one selected from the group consisting of: LiNi_{X}Mn_{(2-X)}O₄ (0<X<2); and Li(Co_{X}Ni_{Y}Mn_{Z})O₂ (0<X<1, 0<Y<1, 0<Z<1, and X+Y+Z=1).

(12) A positive electrode, comprising a metal foil and a coating film of the slurry of any one of (7) to (11) formed on the metal foil.

(13) A lithium ion secondary battery, comprising the positive electrode of (12).

(14) A method for manufacturing the composition of (1) to (5), wherein the graft copolymer is produced by graft copolymerizing the (meth) acrylonitrile and the (meth) acrylic acid ester with the polyvinyl alcohol.

### Advantageous Effects of Invention

The present invention can provide a composition having flexibility

### DESCRIPTION OF EMBODIMENTS

Hereinafter, embodiments for carrying out the present invention will be described in detail. The present invention is not limited to the embodiments described below.

### <Composition (Binder Composition for Positive Electrode)>

A composition of an embodiment of the present invention contains a graft copolymer, as a branch polymer (hereinafter, they may be referred to “poly (meth) acrylonitrile” or “PAN”, and “poly (meth) acrylic acid ester” or “PAK”), in which a monomer, including a (meth) acrylonitrile and a (meth) acrylic acid ester as a main component, graft-copolymerizes to a backbone polymer having polyvinyl alcohol (hereinafter, it may be abbreviated as “PVA”). The graft copolymer is a copolymer, including the (meth) acrylonitrile and the (meth) acrylic acid ester as a main component, graft-copolymerizes to the backbone polymer having polyvinyl alcohol and a (meth) acrylonitrile-(meth) acrylic ester-based copolymer is generated as the branch polymer.

The composition of an embodiment may contains, in addition to the graft copolymer, a (meth) acrylonitrile-(meth) acrylic ester-based copolymer (hereinafter, it may be referred to “non-graft copolymer”, “(meth) acrylonitrile-(meth) acrylic ester based non-graft copolymer”) and/or a non-graft polymer having polyvinyl alcohol. The (meth) acrylonitrile-(meth) acrylic ester-based copolymer and the non-graft polymer having polyvinyl alcohol are not involved in the graft copolymerization. That is, the (meth) acrylonitrile-(meth) acrylic ester based copolymer and the non-graft polymer having polyvinyl alcohol do not form a covalent bond with the graft copolymer and are independent from the graft copolymer. Here, “not forming a covalent bond with” means, for example, “not copolymerizing with”.

Therefore, the composition of an embodiment contains, in addition to the graft copolymer, as a resin component (polymer component), the (meth) acrylonitrile-(meth) acrylic ester-based copolymer and the non-graft polymer having polyvinyl alcohol.

Moreover, the backbone polymer having polyvinyl alcohol as a main component and the non-graft polymer having polyvinyl alcohol are preferably a polyvinyl alcohol homopolymer.

The “non-graft copolymer” may includes not only the (meth) acrylonitrile-(meth) acrylic acid ester-based copolymer but also a homopolymer of each monomer not forming a covalent bond with the graft copolymer.

The (meth) acrylic acid ester in the monomer grafted to the backbone polymer having polyvinyl alcohol is one of monomers to be graft copolymerized thereto.

The (meth) acrylic acid ester of an embodiment is preferably copolymerizable with the (meth) acrylonitrile. The (meth) acrylic acid ester is a monomer in which a homopolymer of the (meth) acrylic acid ester composed only of the (meth) acrylic acid ester, that is a poly (meth)acrylate homopolymer, has a glass transition temperature of 150 to 300 K.

Examples of the (meth) acrylic acid ester whose homopolymer has a glass transition temperature of 150 to 300 K include benzyl acrylate (279 K), butyl acrylate (219 K), 4-cyanobutyl acrylate (233 K), cyclohexyl acrylate (292 K), dodecyl acrylate (270 K), (2-(2-ethoxy) ethoxy) ethyl acrylate (223K), 2-ethylhexyl acrylate (223 K), 1H, 1H-heptafluorobutyl acrylate (243 K), 1H, 1H, 3H-hexafluorobutyl acrylate (251 K), 2,2,2-trifluoroethyl acrylate (263 K), fluoromethyl acrylate (288 K), hexyl acrylate (216 K), isobutyl acrylate (249 K), 2-methoxyethyl acrylate (223 K), dodecyl methacrylate (208 K), hexyl methacrylate (268 K), octyl acrylate (208 K), octadecyl methacrylate (173 K), phenyl methacrylate (268 K), normal octyl acrylate (208 K). A (meth) acrylic acid ester having a functional group such as a nitro group, a haloalkane, an alkylamine, a thioether, an alcohol, or a cyano group may be used as long as the oxidation resistance is not impaired. One or more of these may be used.

The ester group of the (meth) acrylic acid ester preferably has an ester group having one or more structures of the group consisting of linear alkyl, branched alkyl, linear or branched polyether, cyclic ether, and fluoroalkyl, more preferably has an ester group having one or more structures of the group consisting of branched alkyl, linear alkyl, and linear or branched polyether, even more preferably has an ester group having one or more structures of the group consisting of linear alkyl, and linear or branched polyether.

The “glass transition” as used herein refers to a change in which a substance such as glass that is liquid at a high temperature suddenly increases viscosity in a certain temperature range during a temperature drop and almost loses fluidity to become an amorphous solid. A measuring method of the glass transition temperature is not limited in particular, but the glass transition temperature is obtained by the thermogravimetry, the differential scanning calorimetry, the differential calorimetry, and the dynamic viscoelasticity measurement. Among these methods, the dynamic viscoelasticity measurement is preferable.

The glass transition temperatures of homopolymers of (meth) acrylic acid esters are disclosed in J. Org. Brandrup, E. M. H. Immergut, Polymer Handbook, 2nd Ed., J. Wiley, New York 1975, Photocuring Technology Data Book (Technonet Books), etc.

The (meth) acrylonitrile in the monomer grafted to the backbone polymer having polyvinyl alcohol is one kind of monomer to be graft copolymerized thereto.

The upper limit of the ratio of the (meth) acrylonitrile monomer unit and the (meth) acrylic acid ester monomer unit in the monomer unit in the composition may be 100% by mass or less. The proportion of the monomer unit in the composition can be determined by ¹H-NMR (proton nuclear magnetic resonance spectroscopy).

The saponification degree of PVA is, from the viewpoint of oxidation resistance, 50 to 100 mol %. The saponification degree of PVA is, from the viewpoint of increasing the coverage with the positive electrode active material, preferably 80 mol % or more, more preferably 95 mol % or more.

Here, the saponification degree of PVA is a value measured by the method according to JIS K 6726.

The average polymerization degree of PVA is preferably 300 to 3,000 from the viewpoints of solubility, binding properties, and viscosity of the binder composition. The average polymerization degree of PVA is preferably 320 to 2,950, more preferably 500 to 2,500, and even more preferably 500 to 1,800.

When the average polymerization degree of PVA is less than 300, the binding property between the binder, the active material, and the conductive auxiliary agent may be lowered, so that the durability may be lowered. When the average polymerization degree of PVA exceeds 3,000, the solubility is lowered and the viscosity is increased, so that it difficult to produce a slurry for positive electrodes. Here, the average polymerization degree of PVA is a value measured by the method according to JIS K 6726.

The graft ratio of the graft copolymer is preferably from 150 to 1,900%, more preferably from 155 to 1,800%, even more preferably from 200 to 1,500%, and even more preferably from 200 to 900%, from the viewpoint of improving the coverage with the active material. When the graft ratio is less than 150%, the oxidation resistance may decrease. When the graft ratio is more than 900%, the binding property may be lowered.

When producing the graft copolymer (during graft copolymerization), a copolymer by copolymerization of the monomer containing the (meth) acrylonitrile and the (meth) acrylic acid ester (hereinafter, it may be referred to “non-graft copolymer”, “(meth) acrylonitrile-(meth) acrylic ester-based non-graft copolymer”) can be generated. The generated copolymer is are not involved in the graft copolymerization. That is, the generated copolymer do not form a covalent bond with the graft copolymer and are independent from the graft copolymer. Due to the generation of the non-graft copolymer, a process for separating the non-graft copolymer from the composition containing the graft copolymer and the non-graft copolymer is required for the determination of the graft ratio. The non-graft copolymer is soluble in dimethylformamide (hereinafter, it may be referred to as “DMF”), but PVA and the copolymer in which the (meth) acrylonitrile and the (meth) acrylic acid ester are graft copolymerized are insoluble in DMF. Using this difference in solubility, the non-graft copolymer can be separated by an operation such as centrifugation.

Specifically, the composition having known contents of (meth) acrylonitrile monomer unit and (meth) acrylic ester monomer unit is immersed in a predetermined amount of DMF, and the non-graft polymer is eluted in DMF. Next, the liquid in which it is immersed is separated into a DMF soluble part and a DMF insoluble part by centrifugation.

The graft ratio can be determined by the following formula (1).

Graft Ratio=[C−A×(100−B)×0.01]/[A×(100−B)×0.01]×100(%) (1)

In the formula (1), A, B and C are as follows.

A: Amount of the composition of the graft copolymer used for the measurement
B: Amount of the (meth) acrylonitrile monomer unit and the (meth) acrylic ester monomer unit (% by mass) in the composition of the graft copolymer used for the measurement
C: Amount of DMF insoluble content

The weight average molecular weight of the non-graft copolymer is preferably 30,000 to 250,000, more preferably 80,000 to 150,000. From the viewpoint of suppressing the increase in the viscosity due to the non-graft copolymer to easily produce the slurry for positive electrode slurry, the weight average molecular weight of the non-graft copolymer is preferably 250,000 or less, more preferably 190,000 or less, and even more preferably 150,000 or less. The weight average molecular weight of the non-graft copolymer can be determined by GPC (gel permeation chromatography).

A content of the composition of PVA is 5 to 50% by mass, preferably 5 to 40% by mass, and more preferably 5 to 20% by mass. When it is less than 5% by mass, the binding property may be lowered. When it is more than 40% by mass, oxidation resistance and flexibility may be lowered.

Here, the amount of PVA contained in the composition means a proportion, in terms of mass, of a total amount of PVA in the graft polymer and PVA in the non-graft polymer having polyvinyl alcohol, with respect to a total amount of the graft copolymer, the non-graft copolymer and PVA homopolymer, preferably a total amount of the composition.

A total content of the (meth) acrylonitrile monomer unit and the (meth) acrylic acid ester monomer unit is 50 to 95% by mass, preferably 60 to 90% by mass. When the total content of the (meth) acrylonitrile monomer unit and the (meth)acrylate monomer unit in the composition is less than 50% by mass, the oxidation resistance may be lowered. When the total content is more than 95% by mass, the binding property may be lowered.

When the total content of the (meth) acrylonitrile monomer unit and the (meth) acrylic acid ester monomer unit in the composition is 50% by mass or more, the detailed reason is unknown, but it is observed that the amount of Mn and Ni eluted from the positive electrode active material to the negative electrode in the lithium ion secondary battery is reduced.

The total content of the (meth) acrylonitrile monomer unit and the (meth) acrylic acid ester monomer unit in the composition means a proportion thereof in terms of mass with respect to a total amount of the composition which is a total amount of the (meth) acrylonitrile monomer unit and the (meth) acrylic acid ester monomer unit contained in the graft copolymer, the non-graft copolymer and the non-graft polymer having polyvinyl alcohol. That is, it means a proportion, in terms of mass (% by mass), of a total amount of the (meth) acrylonitrile monomer unit and the (meth)acrylate monomer unit included in the graft copolymer and the (meth) acrylonitrile-(meth) acrylic ester non-graft copolymer (non-graft copolymer) which is not involved in the graft copolymerization, with respect to a total amount of the composition.

A content of the (meth) acrylonitrile monomer unit in a total of 100% by mass of the (meth) acrylonitrile monomer unit and the (meth)acrylate monomer unit is 20 to 95% by mass, preferably 30 to 80% by mass, more preferably 40 to 70% by mass.

A content of the (meth)acrylate monomer unit in a total of 100% by mass of the (meth) acrylonitrile monomer unit and the (meth)acrylate monomer unit is 5 to 80% by mass, preferably 20 to 70% by mass, more preferably 30 to 60% by mass.

The composition ratio of the resin component in the composition can be determined on the basis of the conversion (polymerization rate) of the monomer used for the polymerization and the charged amount of each component used for the polymerization.

The mass ratio of the (meth) acrylonitrile monomer unit and the (meth) acrylic acid ester monomer unit in polymers generated by copolymerization, that is a ratio on the basis of a total amount of an amount of the (meth) acrylonitrile monomer unit and the (meth) acrylic acid ester monomer unit graft copolymerized with PVA (a polymer having polyvinyl alcohol) and an amount of the non-graft copolymer, can be calculated on the basis of the polymerization rate of the (meth) acrylonitrile and the (meth) acrylic acid ester and the charged amount of the (meth) acrylonitrile and the (meth) acrylic acid ester. The ratio with respect to the charged amount of the (meth) acrylonitrile and the (meth) acrylic acid ester and the charged amount of PVA can lead the mass ratio of PVA, the (meth) acrylonitrile monomer unit, and the (meth) acrylic acid ester monomer unit.

Specifically, the total amount (% by mass) of the (meth) acrylonitrile monomer unit and the (meth) acrylic acid ester monomer unit in the composition can be determined according to the following formula (2). Here, the monomer means (meth) acrylonitrile or (meth) acrylic acid ester.

Total amount (% by mass) of the (meth) acrylonitrile monomer unit and the (meth) acrylic acid ester monomer unit in the composition can be calculated according to the formula (2):

D×0.01×E/(F+D×0.01×E)×100(%) (2).

Here, in the above formula (2), D, E and F are as follows.

D: Polymerization rate (%) of the monomer used for polymerization

E: Amount of the monomer used for graft copolymerization (charged amount)

F: Amount of PVA used for graft copolymerization (charged amount).

The polymerization rate (D) of the monomer can be determined by ¹H-NMR, but herein, it is a value determined according to the following formula (3).

D=[I−G]/H×100(%) (3)

Here, in the above formula (3), G, H and I are as follows.

G: Amount of PVA used for polymerization

H: Amount of the monomer used for polymerization

I: Amount of the obtained product

The composition ratio of the (meth) acrylonitrile monomer unit and the (meth)acrylate monomer unit in the resin component of the composition can be determined by ¹H-NMR. The measurement of ¹H-NMR can be performed using, for example, “ALPHA500” manufactured by JEOL Ltd., under the conditions of measurement solvent dimethyl sulfoxide, measurement cell: 5 mmφ, sample concentration: 50 mg/1 mL, measurement temperature: 30° C.

The method for manufacturing the composition of the present invention is not particularly limited, but it is preferable that after polymerization of vinyl acetate and saponification to obtain PVA, a monomer mainly composed of (meth) acrylonitrile and (meth) acrylic acid ester is graft-copolymerized to PVA.

As a method for polymerizing vinyl acetate to obtain polyvinyl acetate, any known method such as bulk polymerization or solution polymerization can be used.

Examples of a initiator used for the synthesis of polyvinyl acetate include azo initiators such as azobisisobutyronitrile, and organic peroxides such as benzoyl peroxide, persulfate and bis (4-t-butylcyclohexyl) peroxydicarbonate.

The saponification reaction of polyvinyl acetate can be performed, for example, by a method of saponifying in an organic solvent in the presence of a saponification catalyst.

Examples of the organic solvent include methanol, ethanol, propanol, ethylene glycol, methyl acetate, ethyl acetate, acetone, methyl ethyl ketone, benzene, toluene and the like. One or more of these may be used alone or in combination. Among these, methanol is preferred.

Examples of the saponification catalyst include basic catalysts such as sodium hydroxide, potassium hydroxide and sodium alkoxide, and acidic catalysts such as sulfuric acid and hydrochloric acid. Among these, sodium hydroxide is preferable from the viewpoint of the saponification rate.

Examples of a method for graft copolymerizing a monomer mainly composed of (meth) acrylonitrile and (meth) acrylic acid ester with polyvinyl alcohol (polymer having polyvinyl alcohol) include any polymerization such as solution polymerization, emulsion polymerization, suspension polymerization, and the like. Examples of the solvent used for the solution polymerization or suspension polymerization include dimethyl sulfoxide, N-methylpyrrolidone, and the like.

Examples of an initiator used for graft copolymerization include organic peroxides such as benzoyl peroxide, azo compounds such as azobisisobutyronitrile, potassium peroxodisulfate, ammonium peroxodisulfate, and the like.

The composition of an embodiment can be used by dissolving in a solvent. Examples of the solvent for dissolving the graft copolymer include dimethyl sulfoxide, N-methylpyrrolidone, DMF and the like. One or more of these solvents are contained.

When the composition is dissolved in the solvent to form a solution, the content of the composition in the solution, in terms of solid content, is preferably 1 to 20% by mass, more preferably 2 to 15% by mass, and even more preferably 3 to 10% by mass.

Since the composition of the present invention described in detail above contains the graft copolymer described above, it has high flexibility, good binding properties to the positive electrode active material and the metal foil, and covers the positive electrode active material. Therefore, the composition of the present invention can be used as a binder composition. The binder composition of the present invention can be used as a binder composition for positive electrode. The slurry for positive electrode containing the binder composition for positive electrode can provide a lithium ion secondary battery and a electrode (positive electrode) which can provide the lithium ion secondary battery. The lithium ion secondary battery has cycle characteristics and rate characteristics using high potential positive electrode active materials, is capable of suppressing OCV (storage characteristics) degradation during high temperature storage, and is excellent in electrode flexibility. Therefore, the positive electrode binder composition of the present embodiment is suitable for a lithium ion secondary battery. Therefore, the binder composition for positive electrode of the present invention is suitable for lithium ion secondary batteries.

### <Slurry for Positive Electrode>

The slurry for a positive electrode according to an embodiment contains the positive electrode binder composition, a conductive auxiliary agent, and, if necessary, a positive electrode active material.

### (Conductive Auxiliary Agent)

The slurry for a positive electrode of an embodiment may contain a conductive auxiliary agent. The conductive auxiliary agent is preferably at least one selected from the group consisting of (i) fibrous carbon, (ii) carbon black, and (iii) a carbon composite in which fibrous carbon and carbon black are interconnected. Examples of the fibrous carbon include vapor growth carbon fiber, carbon nanotube, carbon nanofiber, and the like. Examples of the carbon black include acetylene black, furnace black, Ketjenblack (registered trademark), and the like. These conductive auxiliary agents may be used alone or in combination of two or more. Among these, at least one selected from acetylene black, carbon nanotube, and carbon nanofiber is preferable.

### (Positive Electrode Active Material)

The slurry for a positive electrode of an embodiment may contain a positive electrode active material. The positive electrode active material used for a positive electrode is not specifically limited, but preferably at least one selected from the group consisting of a composite oxide including lithium and a transition metal (lithium transition metal composite oxide) and a phosphate including lithium and a transition metal (lithium transition metal phosphate). Examples of the positive electrode active material include lithium transition metal composite oxides such as LiCoO₂, LiNiO₂, Li(Co_{X}Ni_{Y}Mn_{Z})O₂ (0<X<1, 0<Y<1, 0<Z<1, and X+Y+Z=1), Li(Ni_{X}Al_{Y}Co_{Z})O₂ (0<X<1, 0<Y<1, 0<Z<1, and X+Y+Z=1), LiMn₂O₄, LiNi_{X}Mn_{(2-X)}O₄ (0<X<2), combinations of one or more thereof. Among these positive electrode active materials, one or more of positive electrode active materials which has the positive voltage during charging of 4.5V or higher in the charge/discharge curve of the positive electrode of the lithium ion secondary battery, such as LiNi_{X}Mn_{(2-X)}O₄ (0<X<2) and Li(Co_{X}Ni_{Y}Mn_{Z})O₂ (0<X<1, 0<Y<1, 0<Z<1, and X+Y+Z=1), are preferable.

From the viewpoint of high potential, the positive electrode active material is preferably a positive electrode active material that has the positive voltage during charging of 4.5 V or higher in the charge/discharge curve of the positive electrode of the lithium ion secondary battery.

The slurry for a positive electrode of an embodiment may contain a conductive auxiliary agent and to enhance conductivity imparting ability and conductivity of the positive electrode active materials, a carbon composite in which some of conductive auxiliary agents and positive electrode active materials are connected.

In the case of the slurry for electrode of lithium ion secondary battery, examples of the carbon composite include: a carbon composite in which fibrous carbon and carbon black are interconnected; a carbon composite in which a carbon-coated positive electrode active material is composited and integrated with fibrous carbon and carbon black. A carbon composite in which fibrous carbon and carbon black are interconnected to each other can be obtained, for example, by firing a mixture of fibrous carbon and carbon black. The carbon composite can be used to obtain another carbon composite by firing a mixture of the carbon composite and positive electrode active material.

As for the slurry for positive electrode of an embodiment, the contents of the positive electrode binder composition, and the conductive auxiliary agent, if necessary, the positive electrode active material are not particularly limited, but from the viewpoint of improving the binding property and giving good characteristics to lithium ion battery when manufacturing, following ranges are preferable.

The content of the binder composition in the solid content of the slurry for positive electrode is preferably 0.01 to 20% by mass, more preferably 0.1 to 10% by mass, and even more preferably 1 to 3% by mass.

The content of the positive electrode active material in the solid content of the slurry for positive electrode is preferably 50 to 99.8% by mass, more preferably 80 to 99.5% by mass, and even more preferably 95 to 99.0% by mass.

The content of the conductive auxiliary agent in the solid content of the slurry for positive electrode is preferably 0.01 to 10% by mass, more preferably 0.1 to 5% by mass, and most preferably 0.5 to 3% by mass.

Here, the solid content of the slurry for positive electrode is preferably a total amount of the composition for positive electrode, the conductive auxiliary agent, and the positive electrode active material used as needed.

When the content of the conductive auxiliary agent is 0.01% by mass or more, the high-speed chargeability and high output characteristics of the lithium ion secondary battery are improved. When the content is 10% by mass or less, the higher-density positive electrode can be obtained, so that the charge/discharge capacity of the battery is improved.

### <Positive Electrode>

The positive electrode according to an embodiment is manufactured using the above-described slurry for a positive electrode. The positive electrode is preferably manufactured using a metal foil and the above-described slurry for a positive electrode provided on the metal foil. This positive electrode is preferably for a lithium ion secondary battery electrode.

### (Positive Electrode)

The positive electrode of an embodiment is preferably manufactured by applying the above-described slurry for a positive electrode on a metal foil and drying it to form a coating film. The metal foil is preferably a foil-like aluminum. The thickness of the metal foil is preferably 5 to 30 μm from the viewpoint of workability.

### (Method for Manufacturing Positive Electrode)

A well-known method can be used for applying the slurry for a positive electrode on the metal foil. Examples thereof include a reverse roll method, a direct roll method, a blade method, a knife method, an extrusion method, a curtain method, a gravure method, a bar method, a dip method, a squeeze method, and the like. Among these, the blade method (comma roll or die cut), the knife method and the extrusion method are preferable. The coating layer having a favorable surface state can be obtained by selecting a coating method according to the solution physical property and drying property of a binder. The application may be performed on one side or both sides, and in the case of both sides, each side may be applied sequentially or simultaneously. The application may be continuous, intermittent or striped. The thickness of the coating film, length, and width of the slurry for positive electrode may be appropriately determined according to the size of the battery. For example, the thickness of the positive electrode plate including the coating film thickness of the slurry for positive electrode can be in the range of 10 to 500 μm.

As a method for drying the slurry for positive electrode, a generally adopted method can be used. In particular, it is preferable to use hot air, vacuum, infrared rays, far-infrared rays, electron beams and low-temperature air alone or in combination.

The positive electrode can be pressed as needed. As the pressing method, a generally adopted method can be used, and a die pressing method and a calendar pressing method (cold or hot roll) are particularly preferable. The press pressure in the calendar pressing method is not particularly limited, but is preferably 0.1 to 3 ton/cm.

### <Lithium Ion Secondary Battery>

The lithium ion secondary battery according to an embodiment is manufactured using the above-described positive electrode, and preferably it is configured to include the above-described positive electrode, negative electrode, separator, and solution of electrolyte solution (electrolyte and electrolyte solution).

### (Negative Electrode)

The negative electrode used for a lithium ion secondary battery of the present invention is not specifically limited, but it may be manufactured using the slurry for negative electrode containing a negative electrode active material. This negative electrode can be manufactured using, for example, a negative electrode metal foil and a slurry for a negative electrode provided on the metal foil. The slurry for a negative electrode preferably includes a negative electrode binder, a negative electrode active material, and the above-described conductive auxiliary agent. The negative electrode binder is not particularly limited, but for example, polyvinylidene fluoride, polytetrafluoroethylene, styrene-butadiene copolymer, acrylic copolymer, and the like may be used. The negative electrode binder is preferably a fluorine-based resin, more preferably polyvinylidene fluoride and polytetrafluoroethylene, and more preferably polyvinylidene fluoride.

Examples of the negative electrode active material used for the negative electrode include: carbon materials such as graphite, polyacene, carbon nanotube, and carbon nanofiber alloy materials of tin and silicon; oxide materials such as tin oxide, silicon oxide, and lithium titanate. One or more of these may be used.

The metal foil for the negative electrode is preferably foil-like copper, and the thickness of the foil is preferably 5 to 30 μm from the viewpoint of workability. The negative electrode can be manufactured using the slurry for negative electrode and the metal foil for negative electrode by the method according to the manufacturing method of the above-mentioned positive electrode.

### (Separator)

The separator is not particularly limited as long as it has sufficient strength, but for example, electrical insulating porous membrane, mesh, nonwoven fabric, and the like. Any separator can be used as long as it has sufficient strength, such as an electrically insulating porous film, a net, and a nonwoven fabric. In particular, it is preferable to use a material that has low resistance to ion migration of the electrolytic solution and excellent in solution holding. The material is not particularly limited, and examples thereof include: inorganic fibers or organic fibers such as glass fibers; synthetic resins such as polyethylene, polypropylene, polyester, polytetrafluoroethylene, and polyflon; and layered composites thereof. Among them, from the viewpoints of binding properties and safety, it is preferable one or more selected from the group consisting of polyethylene, polypropylene, or layered composites thereof.

### (Electrolyte)

As the electrolyte, any lithium salt can be used. Examples of the electrolyte include LiClO₄, LiBF₄, LiBF₆, LiPF₆, LiCF₃SO₃, LiCF₃CO₂, LiAsF₆, LiSbF₆, LiB₁₀Cl₁₀, LiAlC₄, LiCl, LiBr, LiI, LiB(C₂H₅)₄, LiCF₃SO₃, LiCH₃SO₃, LiCF₃SO₃, LiC₄F₉SO₃, LiN(CF₃SO₂)₂, LiN(C₂F₅SO₂)₂, LiC(CF₃SO₂)₃, lithium fatty acid carboxylate, and the like.

### (Electrolyte Solution)

The electrolyte solution dissolving the electrolyte is not particularly limited. Examples of the electrolyte solution include: carbonates such as propylene carbonate, ethylene carbonate, dimethyl carbonate, diethyl carbonate and methyl ethyl carbonate; lactones such as γ-butyrolactone; ethers such as trimethoxymethane, 1,2-dimethoxyethane, diethyl ether, 2-ethoxyethane, tetrahydrofuran and 2-methyltetrahydrofuran; sulfoxides such as dimethyl sulfoxide; oxolanes such as 1,3-dioxolane and 4-methyl-1,3-dioxolane; nitrogen-containing compounds such as acetonitrile, nitromethane and N-methyl-2-pyrrolidone; esters such as methyl formate, methyl acetate, ethyl acetate, butyl acetate, methyl propionate, ethyl propionate and phosphoric acid triester; inorganic acid esters such as sulfuric acid ester, nitric acid ester and hydrochloric acid ester; amides such as dimethylformamide and dimethylacetamide; glymes such as diglyme, triglyme and tetraglyme; ketones such as acetone, diethyl ketone, methyl ethyl ketone and methyl isobutyl ketone; sulfolanes such as sulfolane; oxazolidinones such as 3-methyl-2-oxazolidinone; sultone such as 1,3-propane sultone, 4-butane sultone and naphtha sultone; and the like. One or more selected from these electrolytic solutions can be used alone or in combination.

Among the above electrolytes and electrolyte solutions, a solution in which LiPF₆ is dissolved in carbonates is preferable. The concentration of the electrolyte in the solution varies depending on the electrode and electrolyte used, but is preferably 0.5 to 3 mol/L.

### EXAMPLES

Hereinafter, the embodiments will be specifically described with reference to examples and comparative examples. The present invention is not limited to this.

### Example 1

### (Preparation of PVA)

600 parts by mass of vinyl acetate and 400 parts by mass of methanol are prepared and degassed by bubbling nitrogen gas. Then, 0.3 parts by mass of bis (4-tert-butylcyclohexyl) peroxydicarbonate was added thereto as a polymerization initiator, polymerization was carried out at 60° C. for 4 hours. The solid content concentration of the polymerization solution when the polymerization was stopped was 48% by mass, and the polymerization rate of vinyl acetate determined on the basis of the solid content was 80%. Methanol vapor was blown into the obtained polymerization solution to remove unreacted vinyl acetate, and then diluted with methanol so that the concentration of polyvinyl acetate was 40% by mass.

20 parts by mass of a methanol solution of sodium hydroxide having a concentration of 10% by mass was added to 1,200 parts by mass of the diluted polyvinyl acetate solution, and a saponification reaction was performed at 30° C. for 2 hours.

The solution after saponification was neutralized with acetic acid, filtered and dried at 100° C. for 2 hours to obtain PVA. The obtained PVA had the average polymerization degree of 320 and the saponification degree of 96.5 mol %.

### <Polymerization Degree and Saponification Degree>

The average polymerization degree and the saponification degree of PVA were measured by a method according to JIS K 6726.

### (Preparation of Binder A)

The preparation method of Binder A is described below. In this example, the binder means a composition containing the graft copolymer according to the present invention.

6.07 parts by mass of the obtained PVA was added to 78.63 parts by mass of dimethyl sulfoxide, and dissolved by stirring at 60° C. for 2 hours. 9.11 parts by mass of acrylonitrile, 5.51 parts by mass of butyl acrylate (glass transition temperature of homopolymer: 219K), and 0.45 parts by mass of ammonium peroxodisulfate dissolved in 3 parts by mass of dimethyl sulfoxide were added thereto at 60° C., and the mixture was stirred at 60° C. to graft-copolymerize them. After 6 hours from the start of the polymerization, the polymerization was stopped by cooling to room temperature.

### (Precipitation/Drying)

100 parts by mass of the reaction solution containing the obtained binder A was dropped into 300 parts by mass of methanol to precipitate the binder A. The polymer was separated by filtration and vacuum-dried at room temperature for 2 hours, and further vacuum-dried at 80° C. for 2 hours. The solid content of the binder was 19.96 parts by mass, and the polymerization rate of acrylonitrile and butyl acrylate was 95% calculated on the basis of the solid content.

The total content of acrylonitrile and butyl acrylate in the obtained binder A was 70% by mass in the binder, the graft ratio was 215%, and the non-graft copolymer (copolymer of acrylonitrile and butyl acrylate) was 76,200, and the composition ratio (mass ratio) of polyvinyl alcohol:acrylonttrile:butyl acrylate in the binder was 30:44:26. These measuring methods will be described below in <Composition Ratio>, <Graft Ratio>, and <Weight Average Molecular Weight>.

### <Composition Ratio>

The composition ratio of the binder A was determined on the basis of the conversion (polymerization rate) of acrylonitrile and butyl acrylate used for the polymerization and the charged amount of each component used for the polymerization. The amount (% by mass) of polyacrylonitrile and polybutyl acrylate produced during the copolymerization (the amount (% by mass) of acrylonitrile and butyl acrylate in the graft copolymer in the binder A) was determined on the basis of the polymerization rate (%) of acrylonitrile and butyl acrylate, the amount of acrylonitrile and butyl acrylate used for the graft copolymerization (charged amount), and the amount of PVA used for the graft copolymerization (charged amount), according to the above-described formulas (2) and (3).

The “mass ratio” in the table below is a mass ratio in the binder resin component containing the graft copolymer itself, and PVA homopolymer, non-graft copolymer (copolymer of acrylonitrile and butyl acrylate) produced during the copolymerization.

### <Graft Ratio>

1.00 g of the binder A was weighed and added to 50 cc of special grade DMF (manufactured by Kokusan Chemical Co., Ltd.) and stirred at 80° C. for 24 hours. Next, the mixture was centrifuged for 30 minutes at a rotational speed of 10,000 rpm with a centrifuge (model: H2000B, rotor: H) manufactured by Kokusan Co., Ltd. After carefully separating the filtrate (DMF soluble component), the pure water insoluble component was vacuum dried at 100° C. for 24 hours, and the graft ratio was calculated according to the above formula (1).

### <Weight Average Molecular Weight>

The filtrate at the time of centrifugation (DMF soluble component) was put into 1000 ml of methanol to obtain a precipitate. The precipitate was vacuum-dried at 80° C. for 24 hours, and the weight average molecular weight in terms of standard polystyrene was measured by GPC. GPC was measured under the following conditions.

Column: two of GPC LF-804, ϕ8.0×300 mm (manufactured by Showa Denko KK) were connected in series

Column Temperature: 40° C.

Solvent: 20 mM LiBr/DMF

### <Oxidative Decomposition Potential>

5 parts by mass of the binder A was dissolved in 95 parts by mass of N-methylpyrrolidone, and 1 part by mass of acetylene black (Denka Black (registered trademark) “HS-100” manufactured by Denka Company Limited) was added to 100 parts by mass of the resulting polymer solution and the mixture was stirred. The obtained mixture was applied on an aluminum foil so that the thickness after drying was 20 μm, preliminarily dried at 80° C. for 10 minutes, and then dried at 105° C. for 1 hour to obtain a test piece.

Using the obtained test piece as the working electrode, lithium as the counter electrode and the reference electrode, and a solution of ethylene carbonate/diethyl carbonate (=½ (volume ratio)) containing the electrolyte salt of LiPF₆ (concentration 1 mol/L) as the electrolyte was used to assemble a triode cell manufactured by Toyo System Co., Ltd. Using the potentio/galvanostat (1287 type) manufactured by Solartron, linear sweep voltammetry (hereinafter abbreviated as “LSV”) was measured at 25° C. and a scanning speed of 10 mV/sec. The oxidative decomposition potential was determined as the potential when the current reached 0.1 mA/cm². It is determined that the higher the oxidative decomposition potential is, the less oxidative decomposition and the higher the oxidation resistance are.

### Example 2

The amount of bis (4-t-butylcyclohexyl) peroxydicarbonate in Example 1 was changed to 0.15 parts by mass, and polymerization was carried out at 60° C. for 5 hours. The polymerization rate was 80%. After removing unreacted vinyl acetate in the same manner as in Example 1, it was diluted with methanol so that the concentration of polyvinyl acetate was 30% by mass. 20 parts by mass of 10% by mass of sodium hydroxide methanol solution was added to 1,900 parts by mass of this polyvinyl acetate solution, and a saponification reaction was carried out at 30° C. for 2.5 hours. Neutralization, filtration and drying were carried out in the same manner as in Example 1 to obtain PVA having an average polymerization degree of 1,640 and a saponification degree of 97.5 mol %.

Acrylonitrile and butyl acrylate were polymerized with the obtained PVA in the same manner as in Example 1 to prepare binder B. The total content of acrylonitrile and butyl acrylate in the obtained binder was 71% by mass in the binder, the graft ratio was 216%, and the non-graft copolymer (copolymer of acrylonitrile and butyl acrylate) was 65,200, and the composition ratio (mass ratio) of polyvinyl alcohol:acrylonitrile:butyl acrylate in the binder was 29:44:27. The composition ratio, graft ratio, and weight average molecular weight of the non-graft copolymer were measured by the same method as in Example 1. The same applies to Example 3 and followings.

### Example 3

PVA was prepared in the same manner as in Example 1 except that the charged amount of polyvinyl acetate in the polymerization was 3,000 parts by mass of vinyl acetate, 0.15 parts by mass of bis (4-tert-butylcyclohexyl) peroxydicarbonate, the reaction time was 12 hours, and the saponification time was 2 hours. The PVA had an average polymerization degree of 3,610 and a saponification degree of 95.1 mol %.

Acrylonitrile and butyl acrylate were polymerized with the obtained PVA in the same manner as in Example 1 to prepare binder C. The polymerization rate of acrylonitrile and butyl acrylate was 89%. The total content of acrylonitrile and butyl acrylate in the obtained binder was 68% by mass in the binder, the graft ratio was 205%, and the non-graft copolymer (copolymer of acrylonitrile and butyl acrylate) was 55,500, and the composition ratio (mass ratio) of polyvinyl alcohol:acrylonitrile:butyl acrylate in the binder was 32:43:25.

### Example 4

PVA was prepared in the same manner as in Example 1 except that the charged amount of polyvinyl acetate in the polymerization was 1,800 parts by mass of vinyl acetate, the reaction time was 12 hours, and the saponification time was 0.5 hours. The PVA had an average polymerization degree of 1,710 and a saponification degree of 63 mol %.

Acrylonitrile and butyl acrylate were polymerized with the obtained PVA in the same manner as in Example 1 to prepare binder D except that 6.07 parts by mass of the obtained PVA was used. The polymerization rate of acrylonitrile and butyl acrylate was 97%. The total content of acrylonitrile and butyl acrylate in the obtained binder was 70% by mass in the binder, the graft ratio was 210%, and the non-graft copolymer (copolymer of acrylonitrile and butyl acrylate) was 65,200, and the composition ratio (mass ratio) of polyvinyl alcohol:acrylonitrile:butyl acrylate in the binder was 30:44:26.

### Example 5

Binder E was prepared by polymerizing at 60° C. for 24 hours in the same manner as in Example 2 except that the amount of acrylonitrile was changed 9.11 parts by mass to 31.63 parts by mass, and the amount of dimethyl sulfoxide was changed 78.63 parts by mass to 157.3 parts by mass. The polymerization rate of acrylonitrile and butyl acrylate was 95%. The total content of acrylonitrile and butyl acrylate in the obtained binder was 86% by mass in the binder, the graft ratio was 551%, and the non-graft copolymer (copolymer of acrylonitrile and butyl acrylate) was 71,100, and the composition ratio (mass ratio) of polyvinyl alcohol:acrylonitrile:butyl acrylate in the binder was 15:73:12.

### Example 6

Binder F was prepared by polymerizing at 60° C. for 6 hours in the same manner as in Example 2 except that the amount of acrylonitrile was changed 9.11 parts by mass to 7.59 parts by mass, and the amount of butyl acrylate was changed 5.51 parts by mass to 18.36 parts by mass. The polymerization rate of acrylonitrile and butyl acrylate was 95%. The total content of acrylonitrile and butyl acrylate in the obtained binder was 80% by mass in the binder, the graft ratio was 390%, and the non-graft copolymer (copolymer of acrylonitrile and butyl acrylate) was 84,300, and the composition ratio (mass ratio) of polyvinyl alcohol:acrylonitrile:butyl acrylate in the binder was 20:23:57.

### Example 7

Binder G was prepared by polymerizing at 60° C. for 6 hours in the same manner as in Example 2 except that the amount of acrylonitrile was changed 9.11 parts by mass to 10.7 parts by mass, and the amount of butyl acrylate was changed 5.51 parts by mass to 1.53 parts by mass. The polymerization rate of acrylonitrile and butyl acrylate was 95%. The total content of acrylonitrile and butyl acrylate in the obtained binder was 66% by mass in the binder, the graft ratio was 170%, and the non-graft copolymer (copolymer of acrylonitrile and butyl acrylate) was 54,300, and the composition ratio (mass ratio) of polyvinyl alcohol:acrylonitrile:butyl acrylate in the binder was 34:58:8.

### Example 8

Binder H was prepared by polymerizing at 60° C. for 6 hours in the same manner as in Example 2 except that 5.51 parts by mass of butyl acrylate was changed to 7.92 parts by mass of normal octyl acrylate (glass transition temperature of homopolymer: 208 K). The polymerization rate of acrylonitrile and normal octyl acrylate was 90%. The total content of acrylonitrile and normal octyl acrylate in the obtained binder was 72% by mass in the binder, the graft ratio was 220%, and the non-graft copolymer (copolymer of acrylonitrile and normal octyl acrylate) was 67,800, and the composition ratio (mass ratio) of polyvinyl alcohol:acrylonitrile:butyl acrylate in the binder was 28:38:34.

### Example 9

Binder I was prepared by polymerizing at 60° C. for 6 hours in the same manner as in Example 2 except that 5.51 parts by mass of butyl acrylate was changed to 7.92 parts by mass of acrylic acid (2-ethylhexyl) (glass transition temperature of homopolymer: 223 K). The polymerization rate of acrylonitrile and acrylic acid (2-ethythexyl) was 90%. The total content of acrylonitrile and normal octyl acrylate in the obtained binder was 72% by mass in the binder, the graft ratio was 240%, and the non-graft copolymer (copolymer of acrylonitrile and acrylic acid (2-ethylhexyl)) was 70,800, and the composition ratio (mass ratio) of polyvinyl alcohol:acrylonitrile:acrylic acid (2-ethylhexyl) in the binder was 28:38:34.

### Example 10

Binder J was prepared by polymerizing at 60° C. for 6 hours in the same manner as in Example 2 except that 5.51 parts by mass of butyl acrylate was changed to 5.59 parts by mass of acrylic acid (2-(2-ethoxy) ethoxy) ethyl (glass transition temperature of homopolymer: 223 K). The polymerization rate of acrylonitrile and acrylic acid (2-(2-ethoxy) ethoxy) ethyl was 85%. The total content of acrylonitrile and acrylic acid (2-(2-ethoxy) ethoxy) ethyl in the obtained binder was 68% by mass in the binder, the graft ratio was 200%, and the non-graft copolymer (copolymer of acrylonitrile and acrylic acid (2-(2-ethoxy) ethoxy) ethyl) was 95,100, and the composition ratio (mass ratio) of polyvinyl alcohol:acrylonitrile:acrylic acid (2-(2-ethoxy) ethoxy) ethyl in the binder was 33:42:26.

### Example 11

Binder K was prepared by polymerizing at 60° C. for 6 hours in the same manner as in Example 2 except that 5.51 parts by mass of butyl acrylate was changed to 6.62 parts by mass of acrylic acid (2,2,2-trifluoroethyl) (glass transition temperature of homopolymer: 263 K). The polymerization rate of acrylonitrile and acrylic acid (2,2,2-trifluoroethyl) was 80%. The total content of acrylonitrile and acrylic acid (2,2,2-trifluoroethyl) in the obtained binder was 67% by mass in the binder, the graft ratio was 201%, and the non-graft copolymer (copolymer of acrylonitrile and acrylic acid (2,2,2-trifluoroethyl)) was 67,300, and the composition ratio (mass ratio) of polyvinyl alcohol:acrylonitrile:acrylic acid (2,2,2-trifluoroethyl) in the binder was 33:39:28.

### Example 12

Binder L was prepared by polymerizing at 60° C. for 6 hours in the same manner as in Example 2 except that the amount of ammonium peroxodisulfate was changed 0.45 parts by mass to 0.05 parts by mass. The polymerization rate of acrylonitrile and butyl acrylate was 92%. The total content of acrylonitrile and butyl acrylate in the obtained binder was 69% by mass in the binder, the graft ratio was 152%, and the non-graft copolymer (copolymer of acrylonitrile and butyl acrylate) was 248,300, and the composition ratio (mass ratio) of polyvinyl alcohol:acrylonitrile:butyl acrylate in the binder was 31:43:26.

### Comparative Example 1

A binder was prepared in the same manner as in Example 2 except that the amount of acrylonitrile was changed 9.11 parts by mass to 12.38 parts by mass and the amount of butyl acrylate was changed 5.51 parts by mass to 0 parts by mass. The polymerization rate of acrylonitrile was 98%. The total content of acrylonitrile in the obtained binder M was 67% by mass in the binder, the graft ratio was 180%, and the non-graft copolymer (homopolymer of acrylonitile) was 76,800, and the composition ratio (mass ratio) of polyvinyl alcohol:acrylonitrile in the binder was 33:67.

### Comparative Example 2

A binder was prepared in the same manner as in Example 2 except that the amount of acrylonitrile was changed 9.11 parts by mass to 8.25 parts by mass and the amount of butyl acrylate was changed 5.51 parts by mass to 0 parts by mass. The polymerization rate of acrylonitrile was 96%. The total content of acrylonitrile in the obtained binder N was 57% by mass in the binder, the graft ratio was 120%, and the non-graft copolymer (homopolymer of acrylonitrile) was 96,900, and the composition ratio (mass ratio) of polyvinyl alcohol:acrylonitrile in the binder was 43:57.

### Comparative Example 3

Binder 0 was prepared by polymerizing at 60° C. for 6 hours in the same manner as in Example 2 except that 5.51 parts by mass of butyl acrylate was changed to 4.30 parts by mass of methyl methacrylate (glass transition temperature of homopolymer 378 K). The polymerization rate of acrylonitrile and methyl methacrylate was 95%. The total content of acrylonitrile and methyl methacrylate in the obtained binder was 68% by mass in the binder, the graft ratio was 200%, and the non-graft copolymer (copolymer of acrylonitrile and methyl methacrylate) was 77,800, and the composition ratio (mass ratio) of polyvinyl alcohol:acrylonitrile: methyl methacrylate in the binder was 32:46:22.

The results are shown in Table 1 for binder A to binder O prepared in Examples 1 to 12 and Comparative Examples 1 to 3.

TABLE 1

| | | Example | | | | | | | |
|---|---|---|---|---|---|---|---|---|---|
| | | 1 | 2 | 3 | 4 | 5 | 6 | 7 | 8 |
| Binder | | A | B | C | D | E | F | G | H |
| Polymerization degree of polyvinyl alcohol | | 320 | 1640 | 3610 | 1710 | 1640 | 1640 | 1640 | 1640 |
| Saponification degree of polyvinyl alcohol | | 96.5 | 97.5 | 95.1 | 63 | 97.5 | 97.5 | 97.5 | 97.5 |
| Mass ratio | Polyvinyl alcohol | 30 | 29 | 32 | 30 | 15 | 20 | 34 | 28 |
| in binder | Acrylonitrile | 44 | 44 | 43 | 44 | 73 | 23 | 58 | 38 |
| (%) | (Meth) acrylic acid ester | 26 | 27 | 25 | 26 | 13 | 57 | 8 | 34 |

| | | | | | | | | |
|---|---|---|---|---|---|---|---|---|
| Graft ratio (%) | 215 | 216 | 205 | 210 | 551 | 390 | 170 | 220 |
| Total content of acrylonitrile and | 70 | 71 | 68 | 70 | 86 | 80 | 66 | 72 |
| (meth) acrylic acid ester (% by mass) | | | | | | | | |
| Weight average molecular weight of | 76200 | 65200 | 55500 | 65200 | 71100 | 84300 | 54300 | 67800 |
| non-graft compolymer | | | | | | | | |
| Oxidative decomposition potential (V) | 6.5 | 6.2 | 6.3 | 6.0 | 6.2 | 6.4 | 6.3 | 6.2 |

| | | Example | | | | Comparative Example | | |
|---|---|---|---|---|---|---|---|---|
| | | 9 | 10 | 11 | 12 | 1 | 2 | 3 |
| Binder | | I | J | K | L | M | N | O |
| Polymerization degree of polyvinyl alcohol | | 1640 | 1640 | 1640 | 1640 | 1640 | 1640 | 1640 |
| Saponification degree of polyvinyl alcohol | | 97.5 | 97.5 | 97.5 | 97.5 | 97.5 | 97.5 | 97.5 |
| Mass ratio | Polyvinyl alcohol | 28 | 33 | 33 | 31 | 33 | 43 | 32 |
| in binder | Acrylonitrile | 38 | 42 | 39 | 43 | 67 | 57 | 46 |
| (%) | (Meth) acrylic acid ester | 34 | 26 | 28 | 26 | 0 | 0 | 2.2 |

| | | | | | | | |
|---|---|---|---|---|---|---|---|
| Graft ratio (%) | 240 | 200 | 201 | 152 | 180 | 120 | 200 |
| Total content of acrylonitrile and | 72 | 68 | 67 | 69 | 67 | 57 | 68 |
| (meth) acrylic acid ester (% by mass) | | | | | | | |
| Weight average molecular weight of | 70800 | 95100 | 67300 | 248300 | 76800 | 96900 | 77800 |
| non-graft compolymer | | | | | | | |
| Oxidative decomposition potential (V) | 6.3 | 6.4 | 6.2 | 6.4 | 6.3 | 6.5 | 6.3 |

The total content of acrylonitrile and (meth) acrylic acid ester is the total content of the acrylonitrile monomer unit and (meth) acrylic acid ester monomer unit in the binder. Non-graft copolymer includes homopolymer of each monomer that is not grafted.

### Example 13

Using the binder A, a slurry for positive electrode was prepared by the following method, and the peel strength was measured. Further, a positive electrode and a lithium ion secondary battery were prepared using the slurry for positive electrode, and the peel strength of the electrode, discharge rate characteristics, cycle characteristics, OCV retention ratio, and flexibility of the electrode were evaluated. The results are shown in Table 2.

TABLE 2

| | | | Example |
|---|---|---|---|
| | | | 13 |
| Composition | Binder | Kind of Binder | A |
| of Slurry | | Amount of binder | 1 |
| | Active Material | LiNi_{0.5}Mn_{1.5}O₄ | 98 |
| | Conductive Auxiliary | Acetylene Black | 1 |
| | Agent | | |
| Evaluation | Peel Strength (mN/mm) | | 175 |
| | High-rate Discharge Capacity Retention | | 82 |
| | Ratio (%) | | |
| | Cycle Capacity Retention Ratio (%) | | 80 |
| | OCV Retention Ratio (%) | | 66 |
| | Flexibility Evaluation | Number of Cracks | 0 |
| | (Observed Cracks) | Max Width of | 0 |
| | | Cracks (cm) | |

### (Preparation of Slurry for Positive Electrode)

5 parts by mass of the obtained binder A was dissolved in 95 parts by mass of N-methylpyrrolidone (hereinafter, abbreviated as NMP) to obtain a binder solution. Further, 1 part by mass of acetylene black (Denka Black (registered trademark) “HS-100” manufactured by Denka Company Limited) and 1 part by mass of the binder solution in terms of solid content were mixed and stirred. After mixing, 98 parts by mass of LiNi_{0.5}Mn_{1.5}O₄ was added and stirred to obtain a slurry for positive electrode.

### <Binding Strength (Peel Strength)>

The prepared slurry for positive electrode was applied to an aluminum foil so that the coating film has a thickness of 100±5 μm after drying and was dried at 105° C. for 30 minutes. Next, it was pressed with a roll press machine at a linear pressure of 0.1 to 3.0 ton/cm so that the positive electrode plate has the average thickness of 75 μm. The obtained positive electrode plate was cut into a width of 1.5 cm, and an adhesive tape was attached to the surface of the positive electrode active material of the cut plate, and a stainless steel plate and the tape attached to the positive electrode plate were stuck together with a double-sided tape. Furthermore, another adhesive tape was attached to the aluminum foil to obtain a test piece. The stress was measured when the adhesive tape attached to the aluminum foil was peeled off at a speed of 50 mm/min in the direction of 180° under an atmosphere of 25° C. and 50% by mass relative humidity. The measurement was repeated 3 times to obtain an average value of the stress, which was defined as peel strength.

### (Preparation of Positive Electrode)

The prepared slurry for positive electrode was applied to an aluminum foil having a thickness of 20 μm by an automatic coating machine so that the coating film has 140 mg/cm² and was preliminarily dried at 105° C. for 30 minutes. Next, it was pressed with a roll press machine at a linear pressure of 0.1 to 3.0 ton/cm so that the positive electrode plate has the average thickness of 75 μm. Furthermore, the positive electrode plate was cut into a width of 54 mm to produce a strip-shaped positive electrode plate. After ultrasonically welding a current collecting tab made of aluminum to the end of the positive electrode plate, in order to completely remove volatile components such as residual solvent and adsorbed moisture, it was dried at 105° C. for 1 hour to obtain a positive electrode.

### (Preparation of Negative Electrode)

96.6 parts by mass of graphite (“Carbotron (registered trademark) P” manufactured by Kureha Corporation) as a negative electrode active material, 3.4 parts by mass in the solid content of polyvinylidene fluoride (“KF polymer (registered trademark) #1120” manufactured by Kureha Corporation) as a binder, and an appropriate amount of NMP was added and mixed with stirring so that the total solid content is 50% by mass, to obtain a slurry of negative electrode.

The prepared slurry for negative electrode was applied to both sides of an cupper foil having a thickness of 10 μm by an automatic coating machine so that each coating film has 70 mg/cm² and was preliminarily dried at 105° C. for 30 minutes. Next, it was pressed with a roll press machine at a linear pressure of 0.1 to 3.0 ton/cm so that the negative electrode plate has the average thickness of 90 μm as the total thickness including the coating films of both sides. Furthermore, the positive electrode plate was cut into a width of 54 mm to produce a strip-shaped positive electrode plate. After ultrasonically welding a current collecting tab made of nickel to the end of the negative electrode plate, in order to completely remove volatile components such as residual solvent and adsorbed moisture, it was dried at 105° C. for 1 hour to obtain a negative electrode.

### (Preparation of Battery)

The obtained positive electrode and negative electrode were combined and wound with a polyethylene microporous membrane separator having a thickness of 25 μm and a width of 60 mm to produce a spiral wound group, which was then inserted into a battery can. Next, 5 ml of a non-aqueous electrolyte solution (ethylene carbonate/methylethyl carbonate=30/70 (mass ratio) mixed solution) in which LiPF₆ was dissolved at a concentration of 1 mol/L as an electrolyte was injected into the battery container. Thereafter, the inlet was caulked and sealed to produce a cylindrical lithium secondary battery having a diameter of 18 mm and a height of 65 mm. The battery performance of the prepared lithium ion secondary battery was evaluated with the following method.

### <Discharge Rate Characteristics (High-Rate Discharge Capacity Retention Ratio)>

The manufactured lithium ion battery was charged at a constant current and a constant voltage limitation of 5.00±0.02 V, 0.2 ItA at 25° C. and then discharged to 3.00±0.02 V at a constant current of 0.2 ItA. Next, the discharge current was changed to 0.2 ItA, 1 ItA and the discharge capacity for each discharge current was measured. In the recovery charge in each measurement, constant current and constant voltage charge of limitation of 5.00±0.02V (1 ItA cut) was performed. And, the capacity retention Ratio (high-rate discharge capacity retention ratio) at 1 ItA discharge with respect to 0.2 ItA discharge was calculated.

### [Cycle Characteristics (Discharge Capacity Retention Ratio)]

At an environmental temperature of 25° C., a constant current and constant voltage charge with a charge voltage of 5.00±0.02 V and 1 ItA and a constant current discharge of 1 ItA with a discharge cut-off voltage of 3.00±0.02 V were performed. The cycle of charging and discharging was repeated, and the ratio of the discharge capacity at 500th cycle to the discharge capacity at the first cycle was determined as the cycle capacity retention ratio.

### <Storage Characteristics (OCV Retention Ratio)>

The lithium ion secondary battery that has been fully charged (5.00±0.02 V) is stored in a 60° C. thermostat, the battery voltage after 96 hours is measured at 60° C., and the voltage retention ratio (OCV retention ratio) is calculated.

The voltage maintenance ratio (OCV retention ratio) was determined by the following equation.

OCV retention ratio=[battery voltage after storage]/[battery voltage before storage]×100(%) (4)

<Flexibility Evaluation (Winding Test with φ15 mm Stick)>

5 parts by mass of the binder A was dissolved in 95 parts by mass of N-methylpyrrolidone, and 5 parts by mass of acetylene black (Denka Black (registered trademark) “HS-100” manufactured by Denka Company Limited) was added to 100 parts by mass of the resulting polymer solution, and the mixture was stirred. The obtained solution was applied on an aluminum foil having the thickness of 20 μm so that the thickness of the positive electrode plate after drying was 75 μm, and dried at 105° C. for 30 minutes to obtain a test piece. The obtained electrode was wound around <φ15 mm stick under the circumstances of an environmental temperature of 20 to 28° C. and a relative humidity of 40 to 60% by mass. The number of cracks and the maximum crack width (maximum crack length) were observed caused by the winding. If no crack is observed when wound, it is evaluated that the flexibility is high.

### Examples 14 to 19

The binder A in Example 13 was changed to the binder shown in Table 3. Other than that, each evaluation was carried out in the same manner as in Example 13. Details are as follows. The results are shown in Table 3.

TABLE 3

| | | | Example | | | | | |
|---|---|---|---|---|---|---|---|---|
| | | | 14 | 15 | 16 | 17 | 18 | 19 |
| Composition | Binder | Kind of Binder | B | D | E | I | J | K |
| of Slurry | | Amount of binder | 1 | 1 | 1 | 1 | 1 | 1 |
| | Active Material | LiNi_{0.5}Mn_{1.5}O₄ | 98 | 98 | 98 | 98 | 98 | 98 |
| | Conductive Auxiliary Agent | Acetylene Black | 1 | 1 | 1 | 1 | 1 | 1 |
| Evaluation | Peel Strength (mN/mm) | | 187 | 178 | 156 | 155 | 178 | 180 |
| | High-rate Discharge Capacity Retention Ratio (%) | | 84 | 82 | 80 | 84 | 72 | 70 |
| | Cycle Capacity Retention Ratio (%) | | 83 | 80 | 77 | 83 | 68 | 67 |
| | OCV Retention Ratio (%) | | 70 | 68 | 66 | 70 | 60 | 60 |
| | Flexibility Evaluation | Number of Cracks | 0 | 0 | 0 | 0 | 0 | 4 |
| | (Observed Cracks) | Max Width of Cracks (cm) | 0 | 0 | 0 | 0 | 0 | 2 |

### Example 14

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder B was used as a binder.

As a result, the high-rate discharge capacity retention ratio was 84%, and the cycle capacity retention ratio was 83%. The OCV retention ratio after 96 hours of storage at 60° C. was 70%. In the winding test with φ915 mm stick was performed for flexibility evaluation, no cracks were observed on the electrode surface.

### Example 15

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder D was used as a binder.

As a result, the high-rate discharge capacity retention ratio was 82%, and the cycle capacity retention ratio was 80%. The OCV retention ratio after 96 hours of storage at 60° C. was 68%. In the winding test with φ15 mm stick was performed for flexibility evaluation, no cracks were observed on the electrode surface.

### Example 16

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder E was used as a binder.

As a result, the high-rate discharge capacity retention ratio was 80%, and the cycle capacity retention ratio was 77%. The OCV retention ratio after 96 hours of storage at 60° C. was 66%. In the winding test with φ915 mm stick was performed for flexibility evaluation, no cracks were observed on the electrode surface.

### Example 17

A slurry for positive electrode, a positive electrode, a negative electrode, and a lithium on secondary battery were prepared and evaluated in the same manner as in Example 13 except that the active material was LiNi_{0.5}Mn_{1.5}O₄ and the binder I was used as a binder.

As a result, the high-rate discharge capacity retention ratio was 84%, and the cycle capacity retention ratio was 83%. The OCV retention ratio after 96 hours of storage at 60° C. was 70%. In the winding test with φ15 mm stick was performed for flexibility evaluation, no cracks were observed on the electrode surface.

### Example 18

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder J was used as a binder.

As a result, the high-rate discharge capacity retention ratio was 72%, and the cycle capacity retention ratio was 68%. The OCV retention ratio after 96 hours of storage at 60° C. was 60%. In the winding test with φ15 mm stick was performed for flexibility evaluation, no cracks were observed on the electrode surface.

### Example 19

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder K was used as a binder.

As a result, the high-rate discharge capacity retention ratio was 70%, and the cycle capacity retention ratio was 67%. The OCV retention ratio after 96 hours of storage at 60° C. was 60%. In the winding test with φ15 mm stick was performed for flexibility evaluation, 4 cracks having maximum crack width of 2 cm were observed on the electrode surface.

### Comparative Examples 4 to 6

The binder A in Example 13 was changed to the binder shown in Table 4. Other than that, each evaluation was carried out in the same manner as in Example 13. Details are as follows. The results are shown in Table 4.

TABLE 4

| | | | Comparative | | |
|---|---|---|---|---|---|
| | | | Example | | |
| | | | 4 | 5 | 6 |
| Composition | Binder | Kind of Binder | M | N | O |
| of Slurry | | Amount of | 1 | 1 | 1 |
| | | binder | | | |
| | Active Material | LiNi_{0.5}Mn_{1.5}O₄ | 98 | 98 | 98 |
| | Conductive | Acetylene | 1 | 1 | 1 |
| | Auxiliary | Black | | | |
| | Agent | | | | |
| Evaluation | Peel Strength | | 189 | 188 | 179 |
| | (mN/mm) | | | | |
| | High-rate Discharge Capacity | | 84 | 83 | 72 |
| | Retention Ratio (%) | | | | |
| | Cycle Capacity Retention Ratio (%) | | 73 | 74 | 60 |
| | OCV Retention | | 65 | 66 | 55 |
| | Ratio (%) | | | | |
| | Flexibility | Number of | 12 | 10 | 17 |
| | Evaluation | Cracks | | | |
| | (Observed Cracks) | Max Width of | 5 | 6 | 4 |
| | | Cracks (cm) | | | |

### Comparative Example 4

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder M was used as a binder.

As a result, the high-rate discharge capacity retention ratio was 84%, and the cycle capacity retention ratio was 73%. The OCV retention ratio after 96 hours of storage at 60° C. was 65%. In the winding test with φ15 mm stick was performed for flexibility evaluation, 12 cracks having maximum crack width of 5 cm were observed on the electrode surface.

### Comparative Example 5

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder N was used as a binder.

As a result, the high-rate discharge capacity retention ratio was 83%, and the cycle capacity retention ratio was 74%. The OCV retention ratio after 96 hours of storage at 60° C. was 66%. In the winding test with φ15 mm stick was performed for flexibility evaluation, 10 cracks having maximum crack width of 6 cm were observed on the electrode surface.

### Comparative Example 6

A slurry for positive electrode, a positive electrode, a negative electrode, and a lithium ion secondary battery were prepared and evaluated in the same manner as in Example 13 except that the active material was LiNi_{0.5}Mn_{1.5}O₄ and the binder O was used as a binder.

As a result, the high-rate discharge capacity retention ratio was 72%, and the cycle capacity retention ratio was 60%. The OCV retention ratio after 96 hours of storage at 60° C. was 55%. In the winding test with φ915 mm stick was performed for flexibility evaluation, 17 cracks having maximum crack width of 4 cm were observed on the electrode surface.

According to the results of Table 4, in the winding test with 915 mm stick was conducted with a binder made by using only acrylonitrile as a monomer to be grafted (Comparative Examples 4 to 5) and a binder obtained by graft copolymerization of methyl methacrylate and acrylonitrile (Comparative Example 6), cracks occurred in the electrode.

The electrode made using the binder of the present invention has high flexibility.

The present invention can provide a binder composition for positive electrode that is good in binding properties and adhesion to electrodes and active materials such as metal foil, oxidation resistance under high voltage, and high electrode flexibility.

Since the binder composition of the present invention has flexibility, no cracks are generated during winding the electrode around the roll in the process of forming the positive electrode of the lithium ion secondary battery.

The positive electrode binder composition of the present invention can provide a battery having excellent cycle characteristics using a positive electrode active material having a high potential.

1. A composition comprising a graft copolymer in which a monomer, including a (meth) acrylonitrile and a (meth) acrylic acid ester as a main monomer, graft-copolymerizes to a backbone polymer having a polyvinyl alcohol, wherein
the polyvinyl alcohol has a saponification degree of 50 to 100 mol %,
a content of the composition of the polyvinyl alcohol is 5 to 50% by mass,
a total content of the (meth) acrylonitrile monomer unit and the (meth) acrylic acid ester monomer unit is 50 to 95% by mass,
a content of the (meth) acrylonitrile monomer unit in a total of 100% by mass of the (meth) acrylonitrile monomer unit and the (meth)acrylate monomer unit is 20 to 95% by mass,
a content of the (meth)acrylate monomer unit in a total of 100% by mass of the (meth) acrylonitrile monomer unit and the (meth)acrylate monomer unit is 5 to 80% by mass,
the (meth) acrylic acid ester is a monomer whose homopolymer has a glass transition temperature of 150 to 300 K.

2. The composition of claim 1, wherein the composition optionally comprises at least one of a (meth) acrylonitrile-(meth) acrylic ester based non-graft copolymer and a non-graft polymer having polyvinyl alcohol.

3. The composition of claim 1, wherein the (meth) acrylic acid ester has one or more structures selected from the group consisting of linear alkyl, branched alkyl, linear or branched polyether, cyclic ether, and fluoroalkyl.

4. The composition of claim 1, wherein a graft ratio of the graft copolymer is 150 to 1,900%.

5. The composition of claim 1, wherein the average polymerization degree of the polyvinyl alcohol is 300 to 3,000.

6. A binder composition for a positive electrode, comprising the composition of claim 1.

7. A slurry for a positive electrode, comprising the binder composition of claim 6 and a conductive auxiliary agent.

8. A slurry for a positive electrode, comprising the binder composition of claim 6, a positive electrode active material and a conductive auxiliary agent.

9. The slurry of claim 7, wherein the conductive auxiliary agent is at least one selected from the group consisting of (i) fibrous carbon, (ii) carbon black, and (iii) a carbon composite in which fibrous carbon and carbon black are interconnected.

10. The slurry of claim 7, wherein a solid content of the binder composition is 0.01 to 20% by mass with respect to a total solid content of the slurry.

11. The slurry of claim 8, wherein the positive electrode active material is at least one member selected from the group consisting of: LiNi_{X}Mn_{(2-X)}O₄ (0<X<2); and Li(Co_{X}Ni_{Y}Mn_{Z})O₂ (0<X<1, 0<Y<1, 0<Z<1, and X+Y+Z=1).

12. A positive electrode, comprising a metal foil and a coating film of the slurry of claim 7 formed on the metal foil.

13. A lithium ion secondary battery, comprising the positive electrode of claim 12.

14. A method for manufacturing the composition of claim 1, wherein the graft copolymer is produced by graft copolymerizing the (meth) acrylonitrile and the (meth) acrylic acid ester with the polyvinyl alcohol.
